(19) United States
(12) Patent Application Publication
(10) Pub. No.: US 2011/0106433 A1
(43) Pub. Date: May 5, 2011

(54) Method of recording and retrieving recent location data, and related personal navigation device

(76) Inventor: Takuya Otani, Auckland (NZ)

(21) Appl. No.: 12/612,666

(22) Filed: Nov. 4, 2009

(51) Int. Cl. G01C 21/00; G06F 3/048

(52) U.S. Cl. 701/202; 701/207; 715/810

(57) ABSTRACT

A method of recording and retrieving data regarding recent locations visited with a personal navigation device includes detecting the personal navigation device staying at a stopping point, the stopping point consisting of a departure point for a trip entered into the personal navigation device, a destination point for a trip entered into the personal navigation device, or a resting point, recording coordinates of the stopping point, a time associated with the stopping point, and a situation type of the stopping point indicating whether the stopping point was a departure point, a destination point, or a resting point, receiving a search query entered by a user of the personal navigation device, and displaying a list of recent stopping points visited by the personal navigation device in response to the search query.

### BACKGROUND OF THE INVENTION

1. Field of the Invention

The invention relates to a personal navigation device, and more particularly, to a personal navigation device that records and facilitates easy lookup of data corresponding to stopping points where the personal navigation device has recently stopped.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Portable GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

As a user navigates from one place to another using the personal navigation device, a log is created and stored in the personal navigation device. The log can contain the precise locations visited, including the longitude and latitude coordinates of each place that the personal navigation device has received GPS signals at. Although the log provides a wealth of information about locations previously visited, the log is not recorded in a user-friendly manner which allows users to easily see which locations the user has visited in the past. The log may have excessive amounts of coordinate data that the user is not able to make sense of without spending a great deal of time deciphering the components of the log and then determining which entries in the log correspond to the locations that the user is interested in. Therefore, there remains a need for a way to enable users to conveniently see a history of locations recently visited with the personal navigation device.

### SUMMARY OF THE INVENTION

It is therefore one of the primary objectives of the claimed invention to provide a method and related personal navigation device for enabling users to see a history of locations recently visited with the personal navigation device. For convenience, the locations can be searched for and sorted according to various data fields.

According to an exemplary embodiment of the claimed invention, a method of recording and retrieving data regarding recent locations visited with a personal navigation device is disclosed. The method includes detecting the personal navigation device staying at a stopping point, the stopping point consisting of a departure point for a trip entered into the personal navigation device, a destination point for a trip entered into the personal navigation device, or a resting point, recording coordinates of the stopping point, a time associated with the stopping point, and a situation type of the stopping point indicating whether the stopping point was a departure point, a destination point, or a resting point, receiving a search query entered by a user of the personal navigation device, and displaying a list of recent stopping points visited by the personal navigation device in response to the search query.

According to another exemplary embodiment of the claimed invention, a personal navigation device for recording and retrieving data regarding recent locations visited with the personal navigation device is disclosed. The personal navigation device includes a processor for controlling operation of the personal navigation device and for detecting the personal navigation device staying at a stopping point, the stopping point consisting of a departure point for a trip entered into the personal navigation device, a destination point for a trip entered into the personal navigation device, or a resting point, a memory for recording coordinates of the stopping point, a time associated with the stopping point, and a situation type of the stopping point indicating whether the stopping point was a departure point, a destination point, or a resting point, and a user interface for receiving a search query entered by a user of the personal navigation device and displaying a list of recent stopping points visited by the personal navigation device in response to the search query.

It is an advantage that users can quickly search for and view locations recently visited with the personal navigation device. In this way, users can more conveniently see which locations were visited in the past, and the users can utilize the personal navigation device to guide the users to revisit selected locations.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 shows a recent location data structure for the recent location data stored in the memory.

FIG. 3 illustrates a screen showing a history of recently visited stopping points grouped according to the date visited.

FIG. 4 illustrates a screen showing a history of recently visited stopping points grouped according to the location area in which the stopping points are located.

### DETAILED DESCRIPTION

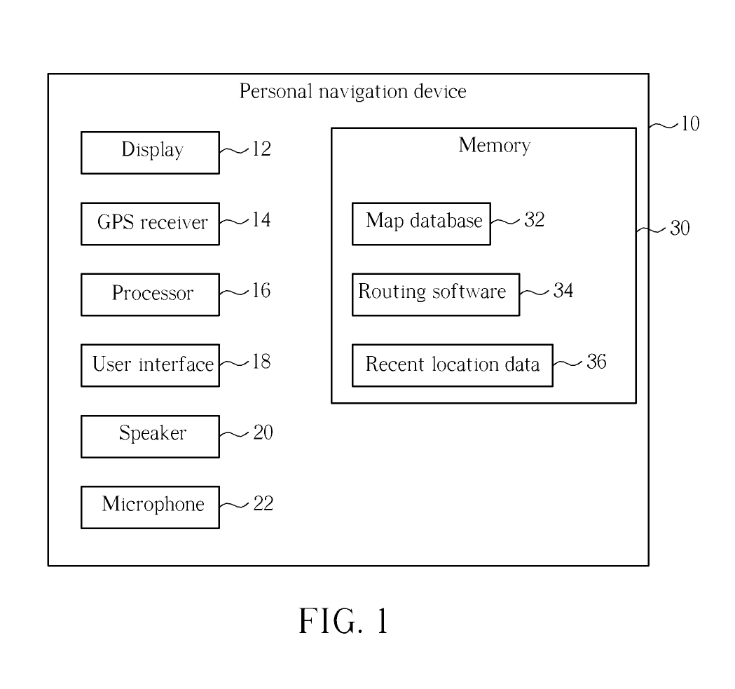

Please refer to FIG. 1. FIG. 1 is a block diagram of a personal navigation device 10 according to the present invention. The personal navigation device 10 contains a display 12 which can be a touch sensitive display, a GPS receiver 14 for receiving the current coordinates of the personal navigation device 10, a processor 16 for controlling operation of the personal navigation device 10, a user interface 18, a speaker 20, a microphone 22, and a memory 30. The memory 30 is used to store a map database 32 containing map data and points of interest. The memory 30 also stores routing software 34 and recent location data 36.

The recent location data 36 stores various locations visited with the personal navigation device 10 along with data pertaining to the different situations in which each recent location was visited. The three main types of locations to be stored in the present invention are the locations where the personal navigation device 10 is at a resting point, destination points on trips for which the personal navigation device 10 provides navigation instructions, as well as departure points on trips for which the personal navigation device 10 provides navigation instructions.

The personal navigation device 10 is determined to be at a resting point when one of several events occurs. First of all, a resting point can be recorded when the personal navigation device 10 remains powered on and stays at the same location for longer than a predetermined time threshold. If the car is located at one point for this period of time, it may be due to either the driver or a passenger of the car staying in the car while someone else leaves the car to run an errand. Second, a resting point may be recorded whenever the external power supply to the personal navigation device 10 is cutoff. For example, when the engine of a car is stopped, external power from the car will be cut off. Third, a resting point may be recorded whenever the user manually switches the personal navigation device 10 to a sleep mode using the user interface 18. When located at the resting point, the user will not usually drive the car right away, but rather will do some other task such as resting, eating, shopping, etc. This extra time spent at the resting point increases the chances that the user may wish to return to the resting point at some point in the future since the user likely stopped at the resting point for a reason.

The recent location data 36 will record the location and date for each of the resting points, destination points, and departure points detected by the personal navigation device 10. When a user saves a location as a favorite location, this action can also be stored in the recent location data 36. Besides the location and date information, the recent location data 36 will also store a situation type, a route type, and an address type corresponding to each location. The situation type indicates whether the location is a resting point, a destination point, or a departure point. The route type indicates whether the location was visited while the user was driving, walking, or in some other mode of transportation. The address type indicates whether the location is a point of interest (POI), a favorite, a street, an intersection, or some other type of location.

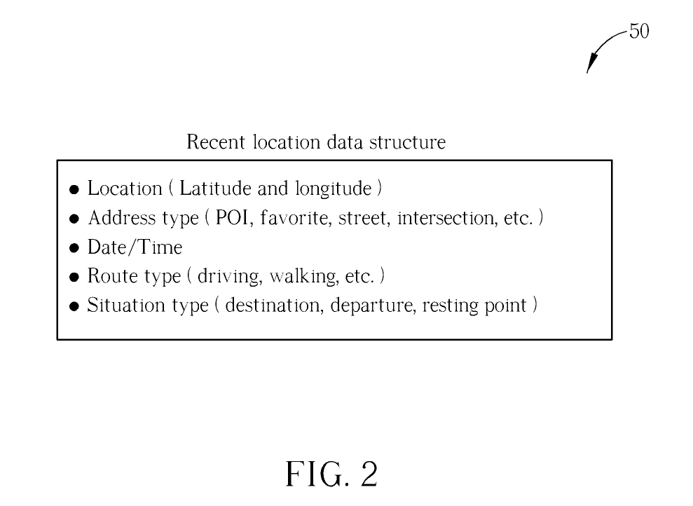

Please refer to FIG. 2. FIG. 2 shows a recent location data structure 50 for the recent location data 36 stored in the memory 30. The recent location data structure 50 stores all or some of the following data for each location stored in the recent location data 36: location data indicating latitude and longitude coordinates of the location, an address type, data or time data pertaining to when the location was visited, route type, and situation type.

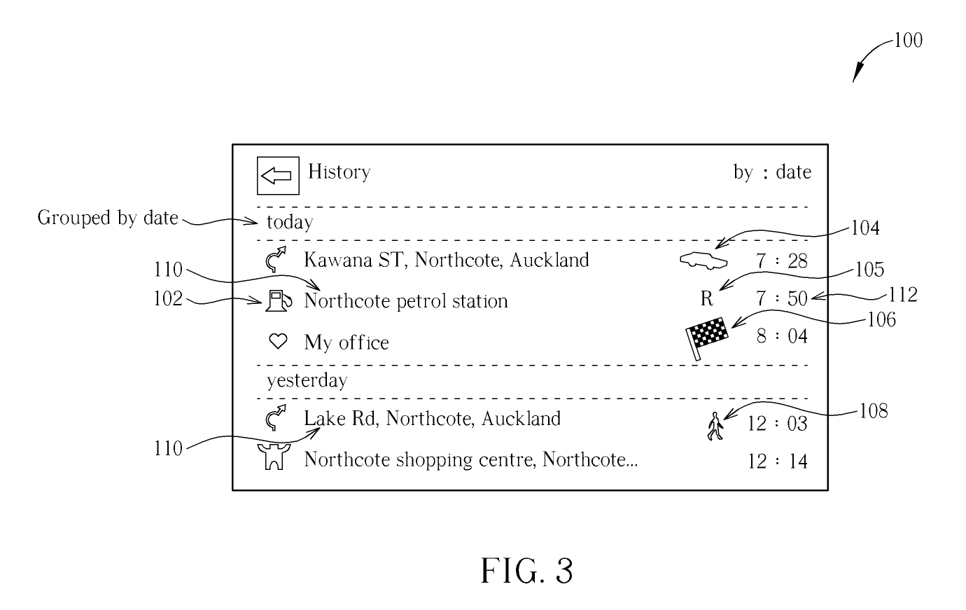

After the recent location data 36 has stored a sufficient number of recent locations visited by the user of the personal navigation device 10, the user can view or search for recently visited stopping points by viewing the history of recent locations. Please refer to FIG. 3. FIG. 3 illustrates a screen 100 showing a history of recently visited stopping points 110 grouped according to the date visited. The stopping points 110 may have icons 102 associated with them indicating the address type of the stopping point 110. For instance, the icon may indicate that the stopping point 110 is a road, a petrol station, a hospital, a restaurant, a favorite place, a shopping center, and so on. Each stopping point 110 will also have an associated date 112 indicating when the stopping point 110 was visited. In this example, the screen 100 shows stopping points 110 that were visited today and yesterday.

The situation type and route type for each stopping point 110 can be displayed as an icon as well. In FIG. 3, icon 104 uses a picture of a car for indicating that the corresponding stopping point 110 was a departure point on a driving route. Icon 105 uses an “R” for indicating that the corresponding stopping point 110 was a resting point. Icon 106 uses a picture of a checkered flag for indicating that the corresponding stopping point 110 was a destination point on a driving route. Icon 108 uses a picture of a pedestrian for indicating that the corresponding stopping point 110 was a departure point on a walking route. By sorting the stopping points 110 according to the date visited, the user can more easily find a recently visited stopping point 110 if the user has a good idea of when the stopping point 110 was previously visited. Other date groupings can also be used besides “today” and “yesterday”, such as “past 7 days”, or “past 30 days”.

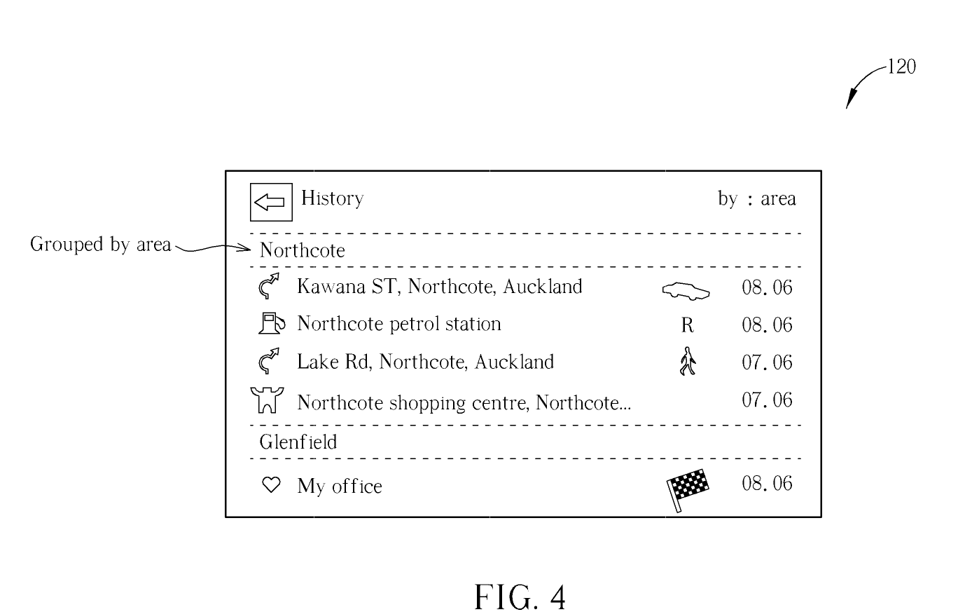

Besides sorting recently visited locations by date, they can also be sorted according to a variety of other fields, such as location, address type, route type, or situation type. Please refer to FIG. 4. FIG. 4 illustrates a screen 120 showing a history of recently visited stopping points 110 grouped according to the location area in which the stopping points 110 are located. In this example, the screen 120 shows stopping points 110 located in the cities of “Northcote” and “Glenfield”. By sorting the stopping points 110 according to their corresponding locations, the user can more easily find a recently visited stopping point 110 if the user has a good idea of where the stopping point 110 is located. Grouping or sorting by area can also sort according to latitude or longitude coordinates instead of grouping by the cities in which the stopping points 110 are located.

When viewing the recently visited stopping points 110 in the history, the user can select one of the stopping points 110 through the user interface 18 and receive routing instructions to the selected stopping point 110 from the routing software 34. In this way, the user can easily revisit a location stored in the recent location data 36 section of memory 30.

In summary, the present invention provides a convenient way to store, view, and search for locations recently visited with the personal navigation device. In this way, users can more conveniently see which locations were visited in the past, and the users can utilize the personal navigation device to guide the users to revisit selected locations.

Those skilled in the art will readily observe that numerous modifications and alterations of the device and method may be made while retaining the teachings of the invention.

What is claimed is:

1. A method of recording and retrieving data regarding recent locations visited with a personal navigation device, the method comprising:
detecting the personal navigation device staying at a stopping point, the stopping point consisting of a departure point for a trip entered into the personal navigation device, a destination point for a trip entered into the personal navigation device, or a resting point;
recording coordinates of the stopping point, a time associated with the stopping point, and a situation type of the stopping point indicating whether the stopping point was a departure point, a destination point, or a resting point;
receiving a search query entered by a user of the personal navigation device; and
displaying a list of recent stopping points visited by the personal navigation device in response to the search query.

2. The method of claim 1, wherein the search query searches for stopping points according to the time associated with the stopping points, and displaying the list of recent stopping points comprises grouping the recent stopping points by time and date.

3. The method of claim 1, wherein the search query searches for stopping points according to the coordinates associated with the stopping points, and displaying the list of recent stopping points comprises grouping the recent stopping points by location.

4. The method of claim 1, wherein the search query searches for stopping points according to the situation types associated with the stopping points, and displaying the list of recent stopping points comprises grouping the recent stopping points by situation type.

5. The method of claim 1 further comprising:
recording an address type of the stopping point indicating what type of location the stopping point is.

6. The method of claim 1 further comprising:
recording a route type associated with the stopping point indicating what type of route the user of the personal navigation device was traveling on when stopping at the stopping point.

7. The method of claim 6, wherein the search query searches for stopping points according to the route type associated with the stopping points, and displaying the list of recent stopping points comprises grouping the recent stopping points by route type.

8. The method of claim 1, wherein a resting point is created when an external power supply is cut off from the personal navigation device.

9. The method of claim 1, wherein a resting point is created when the user of the personal navigation device manually switches the personal navigation device to a sleep mode.

10. The method of claim 1, wherein a resting point is created when the personal navigation device remains powered on and stays in the same location for longer than a predetermined time threshold.

11. The method of claim 1 further comprising:
the user selecting a stopping point from the list of recent stopping points; and
the personal navigation device providing navigation instructions for guiding the user to the selected stopping point.

12. A personal navigation device for recording and retrieving data regarding recent locations visited with the personal navigation device, the personal navigation device comprising:
a processor for controlling operation of the personal navigation device and for detecting the personal navigation device staying at a stopping point, the stopping point consisting of a departure point for a trip entered into the personal navigation device, a destination point for a trip entered into the personal navigation device, or a resting point;
a memory for recording coordinates of the stopping point, a time associated with the stopping point, and a situation type of the stopping point indicating whether the stopping point was a departure point, a destination point, or a resting point; and
a user interface for receiving a search query entered by a user of the personal navigation device and displaying a list of recent stopping points visited by the personal navigation device in response to the search query.

13. The personal navigation device of claim 12, wherein the search query searches for stopping points according to the time associated with the stopping points, and displays the list of recent stopping points by grouping the recent stopping points by time and date.

14. The personal navigation device of claim 12, wherein the search query searches for stopping points according to the coordinates associated with the stopping points, and displays the list of recent stopping points by grouping the recent stopping points by location.

15. The personal navigation device of claim 12, wherein the search query searches for stopping points according to the situation types associated with the stopping points, and displays the list of recent stopping points by grouping the recent stopping points by situation type.

16. The personal navigation device of claim 12, wherein the memory records an address type of the stopping point indicating what type of location the stopping point is.

17. The personal navigation device of claim 12, wherein the memory records a route type associated with the stopping point indicating what type of route the user of the personal navigation device was traveling on when stopping at the stopping point.

18. The personal navigation device of claim 17, wherein the search query searches for stopping points according to the route type associated with the stopping points, and displays the list of recent stopping points by grouping the recent stopping points by route type.

19. The personal navigation device of claim 12, wherein a resting point is created when an external power supply is cut off from the personal navigation device.

20. The personal navigation device of claim 12, wherein a resting point is created when the user of the personal navigation device manually switches the personal navigation device to a sleep mode.

21. The personal navigation device of claim 12, wherein a resting point is created when the personal navigation device remains powered on and stays in the same location for longer than a predetermined time threshold.

22. The personal navigation device of claim 12, wherein in response to the user interface receiving a user's selection of a stopping point from the list of recent stopping points, the personal navigation device provides navigation instructions for guiding the user to the selected stopping point.
